(19) United States
(12) Patent Application Publication
(10) Pub. No.: US 2020/0028294 A1
(43) Pub. Date: Jan. 23, 2020

(54) TERMINAL

(71) Applicant: Yazaki Corporation, Tokyo (JP)

(72) Inventors: Yasunari NAGANO, Shizuoka (JP); Shingo Chiba, Shizuoka (JP); Naokazu Nagasaka, Shizuoka (JP); Dacheng Jin, Shizuoka (JP); Atsuhito Saito, Shizuoka (JP)

(73) Assignee: Yazaki Corporation, Tokyo (JP)

(21) Appl. No.: 16/512,486

(22) Filed: Jul. 16, 2019

(30) Foreign Application Priority Data
Jul. 17, 2018 (JP) 2018-134082

(51) Int. Cl. H01R 13/11; H01R 4/18

(52) U.S. Cl. CPC H01R 13/11; H01R 4/185

(57) ABSTRACT

A terminal is provided with a box portion having four wall portions formed by bending a single plate, and a bending spring portion arranged in the box portion. A mating terminal is inserted into the box portion in a state in which the bending spring portion is bent and deformed, and the terminal comes into contact with the mating terminal with a bending restoration force of the bending spring portion applied as a contact load. One of one wall portion located at one end of the bending and the other wall portion adjacent to the one wall portion is provided with a locking hole, and the other is provided with a locking piece which is bent and enters the locking hole by the bending.

### BACKGROUND

### Technical Field

The present disclosure relates to a terminal in which a bending spring portion is arranged in a box portion.

### Related Art

A conventional terminal is described in Japanese patent application laid-open No. JP 2004-31034 A. This terminal has a box portion whose front face is open. The box portion is formed of a bottom wall, a pair of side walls and a ceiling wall in a single plate. A locking hole is formed in one side wall. A locking piece extends on the ceiling wall. A locking piece extending from the ceiling wall is bent and enters the locking hole.

In the box portion, a bending spring portion of a cantilever support structure, one end of which is supported by the box portion, is provided.

A mating terminal (not illustrated) inserted in the box portion is sandwiched between the bending spring portion and the ceiling wall, and the terminals are electrically connected with each other with a spring restoration force of the bending spring portion applied as a contact load.

According to the above terminal, when the mating terminal (not illustrated) is inserted into the box portion, the external force in the direction in which the box portion is opened acts between one side wall and the ceiling wall by the spring restoration force of the bending spring portion. Receiving this external force by the locking hole and the locking piece suppresses the displacement in the direction in which the box portion is opened. Thereby, reduction in the contact load due to reduction in the spring restoration force of the bending spring portion is suppressed.

### SUMMARY

However, in the conventional terminal, a large clearance is formed between the end faces of both the locking hole and the locking piece that restrict the displacement in the direction in which the box portion is opened.

Specifically, both the end faces of the locking hole and the locking piece that restrict the displacement in the direction in which the box portion is opened have a linear shape. If the dimensions are set so that no clearance is generated between the end faces of both the locking hole and the locking piece, both end faces when the locking piece extending from the ceiling wall is bent and made to enter the locking hole interfere with each other in a linearly overlapped state. Therefore, the locking piece cannot be made to enter the locking hole by bending. Therefore, it is necessary to set the dimensional relationship so as not to interfere with each other when the locking piece is bent and enters the locking hole. However, when set in such a dimensional relationship, a large clearance occurs when the locking piece enters the locking hole.

Therefore, in the conventional terminal, since the displacement is possible in the direction in which the box portion is opened by the clearance, there is a problem that the spring restoration force of the bending spring portion is reduced and the contact load is reduced.

The present disclosure is made to solve the above-mentioned problem and an object of the present disclosure is to provide a terminal which can suppress reduction in a spring load of a bending spring portion resulting from an external force in the direction in which the box portion is opened.

According to an embodiment of the present disclosure, a terminal includes a box portion having a plurality of wall portions formed by bending a single plate, and a bending spring portion arranged in the box portion, a mating terminal being inserted into the box portion in a state in which the bending spring portion is bent and deformed, the terminal coming into contact with the mating terminal with a bending restoration force of the bending spring portion applied as a contact load, in which, of a first wall portion located at one end of the bending and a second wall portion adjacent to the first wall portion, the first wall portion is provided with a locking hole, and the second wall portion is provided with a locking piece which is bent and enters the locking hole, and one of end faces of the locking hole and the locking piece which restrict a displacement in a direction in which the box portion is opened is formed in a linear-shaped end face and the other is formed in a point-shaped end face.

According to the above configuration, when the locking piece of the second wall portion is bent and made to enter the locking hole of the first wall portion at the time of assembly of the box portion, even if the dimensional relationship is set to have a small clearance so that the end faces which regulate the displacement in the direction in which the box portion is opened interference with each other, a portion constituting the point-shaped end face can be deformed. Therefore, the locking piece can be made to enter the locking hole, and the clearance between the end faces that restrict the displacement in the direction in which the box portion is opened can be minimized. Therefore, the displacement of the direction in which the box portion is opened can be small in a suppressed manner, and it is possible to suppress reduction in a spring load of a bending spring portion resulting from an external force of an opening direction of a box portion.

### BRIEF DESCRIPTION OF DRAWINGS

FIG. 1 illustrates an embodiment of the present disclosure and is a perspective view of a terminal;

FIG. 2 illustrates an embodiment of the present disclosure and is a side view of the terminal;

FIG. 3 illustrates an embodiment of the present disclosure and is a cross-sectional view of the terminal;

FIG. 4 illustrates an embodiment of the present disclosure and is a perspective view of a principal part of the terminal;

FIGS. 5A and 5B illustrate an embodiment of the present disclosure, FIG. 5A is a side view of a principal part of the terminal, and FIG. 5B is an enlarged view of a portion A of FIG. 5A; and

FIGS. 6A and 6B illustrate an embodiment of the present disclosure, FIG. 6A is a side view illustrating a state in which a locking piece and the end face of a locking hole interfere with each other when the locking piece is made to enter the locking hole, and FIG. 6B is a cross-sectional view taken along line 6B-6B of FIG. 6A.

### DETAILED DESCRIPTION OF EMBODIMENT

Hereinafter, an embodiment of the present disclosure will be described based on the drawings.

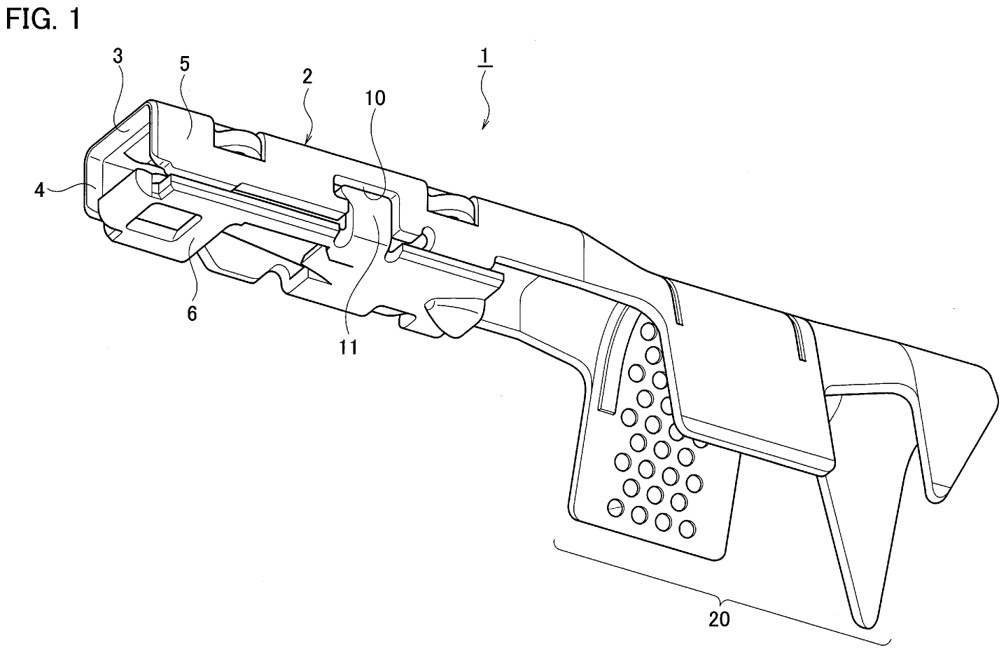

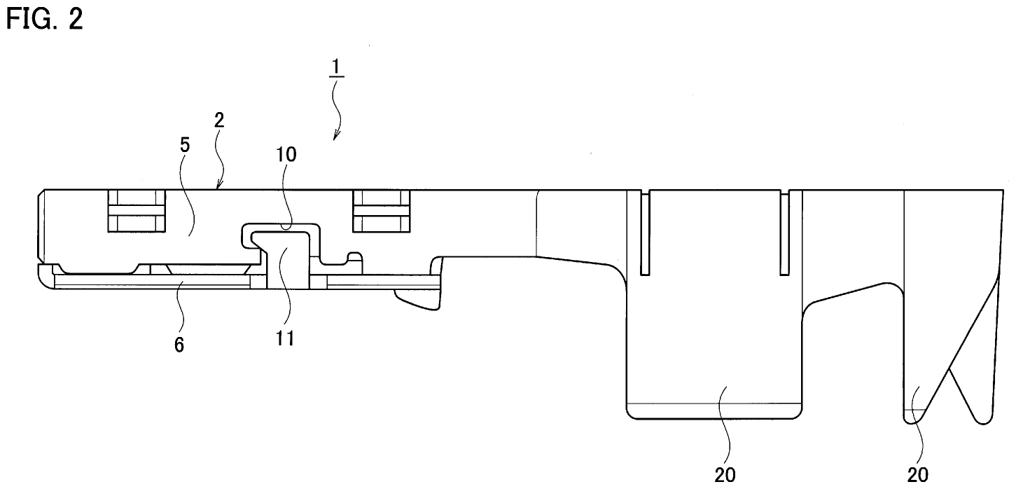

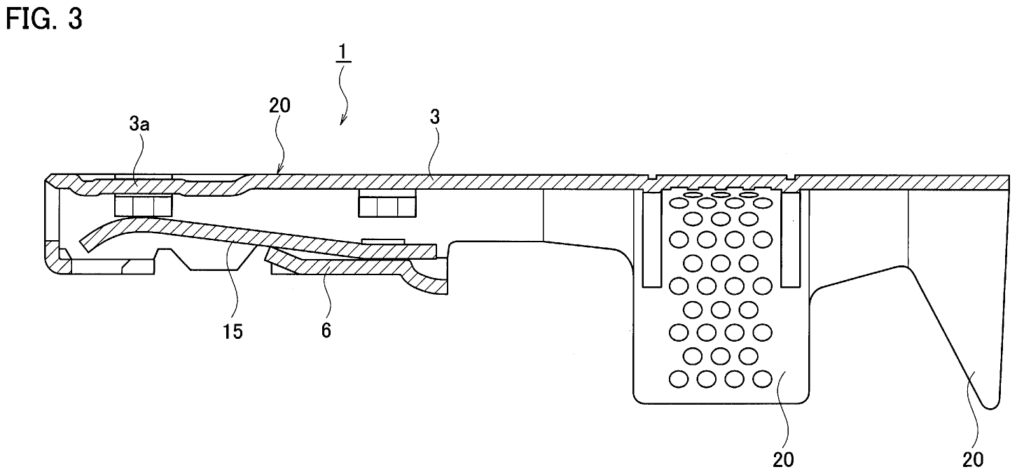

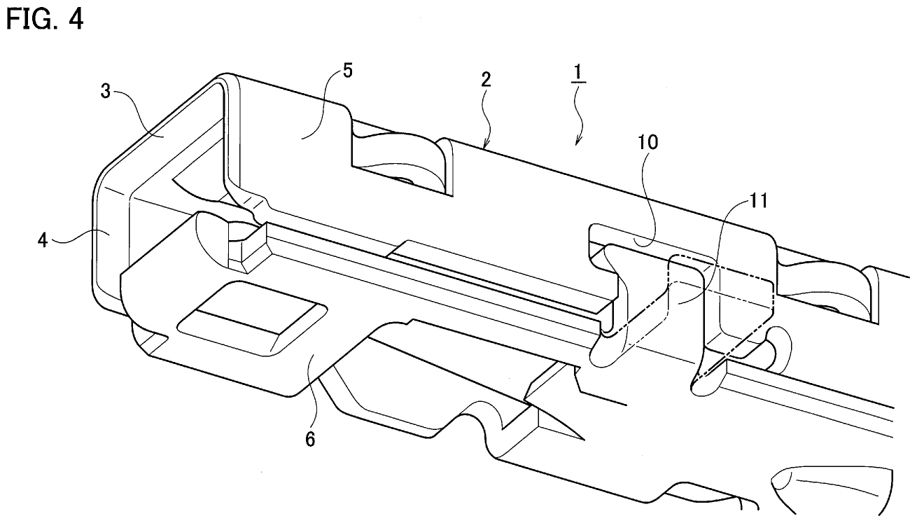

FIGS. 1 to 6B illustrate an embodiment of the present disclosure. In the drawings, a bottom wall 3 is illustrated above and a ceiling wall 6 is illustrated below.

A female terminal 1, which is a terminal, is formed by bending a single conductive plate (copper material or the like) having a predetermined shape. The female terminal 1 includes a box portion 2 electrically connected to a male terminal (not illustrated), which is a mating terminal, and a cable connection portion 20 for connecting a cable (not illustrated).

The box portion 2 has a rectangular elongated box shape whose front side and rear side are opened. The box portion 2 is formed of the bottom wall 3, a pair of side walls 4 and 5, and the ceiling wall 6, which are four wall portions. The bottom wall 3 has a tab receiving face 3a that projects toward the ceiling wall 6 by bending. One side wall 4 is integrally provided from one side end of the bottom wall 3 via a bent portion. The other side wall 5 (first wall portion or second wall portion) is integrally provided with the other side end of the bottom wall 3 via a bent portion. The side wall 5 is located at one end of the bending while the ceiling wall 6 is located at the other end of the bending. A ceiling wall 6 is arranged adjacent to the side wall 5. The side wall 5 is provided with a locking hole 10 opening toward the end face of the ceiling wall 6.

The ceiling wall 6 (first wall portion or second wall portion) is integrally provided with the side wall 4 via a bent portion. A locking piece 11 is provided protruding from the ceiling wall 6. The locking piece 11 is bent at the base and enters the locking hole 10 of the side wall 5. Thus, the locking piece 11 is arranged flush with the side wall 5. The detailed configuration of the locking hole 10 and the locking piece 11 will be described below.

A bending spring portion 15 is arranged in the box portion 2. The bending spring portion 15 extends from the ceiling wall 6, and the tip thereof is a free end. That is, the bending spring portion 15 has a cantilever support structure.

A male terminal (not illustrated), which is a mating terminal, is provided with a flat and elongated tab portion and a cable connection portion for connecting a cable.

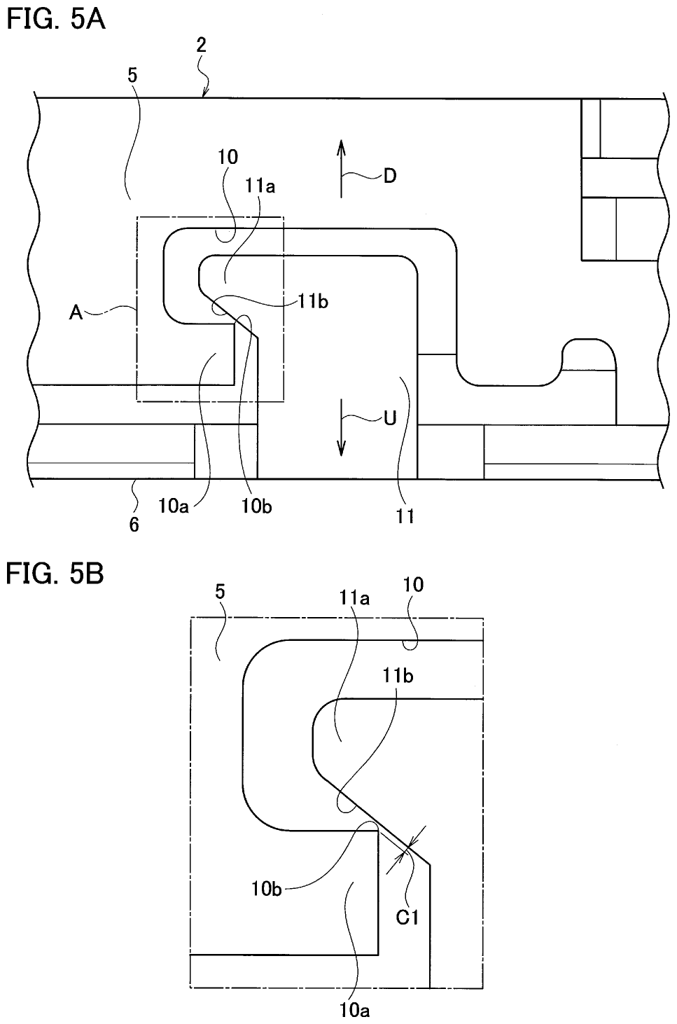

Next, the structures of the locking hole 10 and the locking piece 11 will be described. As illustrated in FIGS. 5A and 5B, the locking hole 10 is formed in a substantially square hole shape. A projection piece 10a projects from the side wall 5 to the locking hole 10. The locking piece 11 is formed in a substantially square wall shape. A projection piece 11a projects from the locking piece 11. The locking hole 10 and the locking piece 11 respectively have end faces 10b and 11b that restrict the displacement in the directions U and D in which the box portion 2 is opened. That is, when the displacement in the directions U and D in which the box portion 2 is opened is caused, the end face 10b comes into contact with the end face 11b to restrict the displacement.

The end face 10b of the locking hole 10 is formed in the projection piece 10a, and is formed of an angular face in which a linear face orthogonal to the direction D in which the box portion is opened and a linear face along the direction D in which the box portion is opened intersect, that is, a point-shaped face.

The end face 11b of the locking piece 11 is formed on the projection piece 11a, and is formed of a linear face extending obliquely with respect to the direction U in which the box portion 2 is opened. A small clearance C1 (see FIG. 5B) or an almost no clearance is arranged between the point-shaped end face 10b toward the locking hole 10 and the linear-shaped end face 11b toward the locking piece 11. The reason for being able to arrange them in such a state of clearance is as follows.

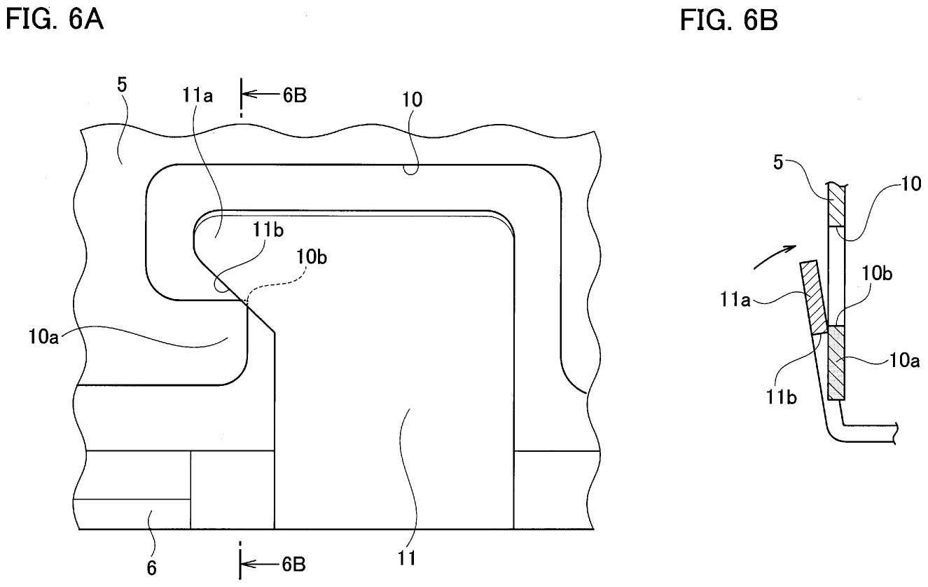

That is, when the locking piece 11 of the ceiling wall 6 is bent and made to enter into the locking hole 10 of the side wall 5 at the time of assembly of the box portion 2, as illustrated in FIGS. 6A and 6B, even if the dimensional relationship is set such that the end faces 10b and 11b restricting the displacement in the directions U and D in which the box portion 2 is opened interfere with each other, since the portion constituting the point-shaped end face 10b, that is, the tip end portion of the projection piece 10a, can be deformed (much deformable, compared the linear tip end), the locking piece 11 can be made to enter the locking hole 10. Therefore, the clearance C1 between the end faces 10b and 11b that restrict the displacement in the directions U and D in which the box portion 2 is opened can be minimized.

Further, when the locking piece 11 of the ceiling wall 6 is bent and made to enter the locking hole 10 of the side wall 5 at the time of assembly of the box portion 2, the locking piece 11 may be bent so that the end faces 10b and 11b that restrict the displacement in the directions U and D in which the box portion 2 is opened contact each other only at one point. In other words, the locking piece 11 may be bent so as to contact the end face 10b with one point as a target. Therefore, it is possible to perform easy bending with the clearance C1 as small as possible. Therefore, the clearance C1 between the end faces 10b and 11b that restrict the displacement in the directions U and D in which the box portion 2 is opened can be minimized. As a result, in the state where the male terminal (not illustrated) is inserted into the box portion 2, the external forces in the directions U and D in which the box portion 2 is opened act on the box portion 2. At this time, the displacement in the directions U and D in which the box portion 2 is opened can be small in a suppressed manner. For this reason, the reduction in the spring load of the bending spring portion 15 resulting from an opening of the box portion 2 can be suppressed.

As described above, the female terminal 1 is configured such that the ceiling wall (wall portion) 6 located at one end of the bending and the other side wall (the other wall portion) 5 adjacent to the ceiling wall (wall portion) 6 are provided with the locking hole 10 and the locking piece 11, respectively. One of the end faces 10b and 11b of both the locking hole 10 and the locking piece 11 that restrict the displacement of the directions U and D in which the box portion 2 is opened is formed in the linear-shaped end face 11b and the other is formed in the point-shaped end face 10b. Therefore, for the reasons described above, the displacement in the directions U and D in which the box portion 2 is opened can be small in a suppressed manner, and the reduction in the spring load of the bending spring portion 15 due to the opening of the box portion 2 can be suppressed.

Moreover, one end face 10b that restricts the displacement in the directions U and D in which the box portion 2 is opened is point-shaped. Therefore, when an external force in the directions U and D in which the box portion 2 is opened acts, the one point-shaped end face 10b bites into the other linear-shaped end face 11b, so the displacement in the directions U and D in which the box portion 2 is opened can be reliably restricted. That is, if both the end faces 10b and 11b have a linear shape, when an external force in the directions U and D in which the box portion 2 is opened acts, slippage occurs between the end faces 10b and 11b, and it is probable that the displacement in the directions U and D in which the box portion 2 be large. Such a situation does not occur in the present embodiment.

Furthermore, it is easy to visually identify whether the end faces 10b and 11b are in proper contact with each other. That is, it is easier to visually identify that both the end faces 10b and 11b are in contact with each other at one point than to visually validate that the end faces 10b and 11b are in surface contact with each other.

In this embodiment, the end face 10b of the locking hole 10 is formed in a point shape, and the end face 11b of the locking piece 11 is formed in the linear-shaped end face 11b. However, the end face 10b of the locking hole 10 may be formed in a linear shape, and the end face 11b of the locking piece 11 may be formed in a point shape. Further, the end face 11b is not limited to have a linear shape, and may have a curved shape.

What is claimed is:

1. A terminal comprising:
a box portion having a plurality of wall portions formed by bending a single plate; and
a bending spring portion arranged in the box portion,
wherein a mating terminal is inserted into the box portion in a state in which the bending spring portion is bent and deformed, the terminal coming into contact with the mating terminal with a bending restoration force of the bending spring portion applied as a contact load,
wherein, of a first wall portion located at one end of the bending and a second wall portion adjacent to the first wall portion, the first wall portion is provided with a locking hole, and the second wall portion is provided with a locking piece which is bent and enters the locking hole, and
wherein one of end faces of the locking hole and the locking piece which restrict a displacement in a direction in which the box portion is opened is formed in a linear-shaped end face and the other is formed in a point-shaped end face.

2. The terminal according to claim 1,
wherein the linear-shaped end face extends obliquely with respect to the direction in which the box portion is opened.

3. The terminal according to claim 1,
wherein the locking piece is bent flush with the first wall portion.

4. The terminal according to claim 1,
wherein the first wall portion is a side wall, and the second wall portion is a ceiling wall.

5. The terminal according to claim 1,
wherein an end face of the locking hole is formed in a point-shaped face.
